(19) United States
(12) Patent Application Publication
(10) Pub. No.: US 2007/0038681 A1
(43) Pub. Date: Feb. 15, 2007

(54) System and method of remote storage of data through connection from a server to a client

(75) Inventors: Jason Pierce, Bermuda Dunes, CA (US); Cery Perle, Palm Desert, CA (US)

Correspondence Address: PILLSBURY WINTHROP SHAW PITTMAN LLP, P.O BOX 10500, McLean, VA, 22102, US

(73) Assignee: Spare Backup, Inc., Palm Desert, CA (US)

(21) Appl. No.: 11/502,169

(22) Filed: Aug. 10, 2006

Related U.S. Application Data
(60) Provisional application No. 60/707,443, filed on Aug. 10, 2005.

(51) Int. Cl. G06F 17/30

(52) U.S. Cl. 707/201

(57) ABSTRACT

A client computer stores data on a server at a remote location. The server receives a request to start an upload session and transmits a session key to the client computer. The server receives logon information and a hardware identification from the client computer and verifies the client computer's authenticity. The server receives a start upload request from the client computer and updates an upload history for the client computer. The server receives an upload command from the client computer and the upload command includes a file name. The server sends a file identification to the client computer, the file identification corresponding to the file name. The server receives a file corresponding to the file name from the client computer and transfers the file to an attached storage. The server receives a finish upload command from the client computer.

### RELATED APPLICATIONS

This application claims priority to provisional application Ser. No. 60/707,443, filed Aug. 10, 2005, attorney docket number 071730-0317186.

### BACKGROUND OF THE INVENTION

In many corporate and enterprise environments, users utilize desktop computers, laptop computers, network computers, and other portable computers to connect to the network. The portable computers utilize many network resources during operation. In many cases, the portable computers are executing client—server applications where some of the executable software is located on the client computer and some of the executable software is located on the server.

In many cases, the user transports the portable computer from home to the office, from one corporate location to another corporate location (e.g., when the user is a salesperson), or from home to a wireless hotspot. If the main storage unit, e.g., a hard drive or a removable drive, fails in the portable computer, the user can lose valuable data. Although users are instructed to back up their data on a regular basis, the complexity of the portable computer's operating systems and application software makes it difficult for the user to know exactly what to backup off their portable computer.

In many corporations or organizations, a number of similar portable computers may be distributed to the individuals. The system administrator for the organization may wish to establish a backup policy for all individuals. However, it is difficult to make sure that the individuals conform to the same backup policy or even backup the distributed portable computers. Thus, a high risk exists that data may be lost because the users did not abide by the organizational backup policy.

Accordingly, a need exists for a backup program that automatically backs up and stores data from the user's portable computer and interacts with a server system, which is programmed to store a plurality of user's data from a plurality of client computers.

### BRIEF DESCRIPTION OF THE DRAWINGS

The present invention is illustrated by way of example, not limitation, in the figures of the accompanying drawings, in which like references indicate similar elements and wherein:

FIG. 1A illustrates a network topology that includes a plurality of nodes and elements of the invention according to certain embodiments of the present invention;

FIG. 1B illustrates a network topology of a node within the network topology depicted in FIG. 1A;

FIG. 2 illustrates a process for uploading according to certain embodiments of the present invention;

FIG. 3 illustrates a process for downloading according to certain embodiments of the present invention;

FIG. 4 illustrates a process for scanning files for viruses according to certain embodiments of the present invention;

FIG. 5 illustrates a process for optimizing files according to certain embodiments of the present invention;

FIG. 6 illustrates a quick download request according to an embodiment of the invention; and

FIG. 7 illustrates creating a self-extracting executable for download according to an embodiment of the present invention

### DETAILED DESCRIPTION

The present invention will now be described in detail with reference to the drawings, which are provided as illustrative examples of the invention so as to enable those skilled in the art to practice the invention. Notably, the implementation of certain aspects of the present invention may be accomplished using software, hardware or any combination thereof, as would be apparent to those of ordinary skill in the art, and the Figures and examples below are not meant to limit the scope of the present invention. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Further, the present invention encompasses present and future known equivalents to the known components referred to herein by way of illustration.

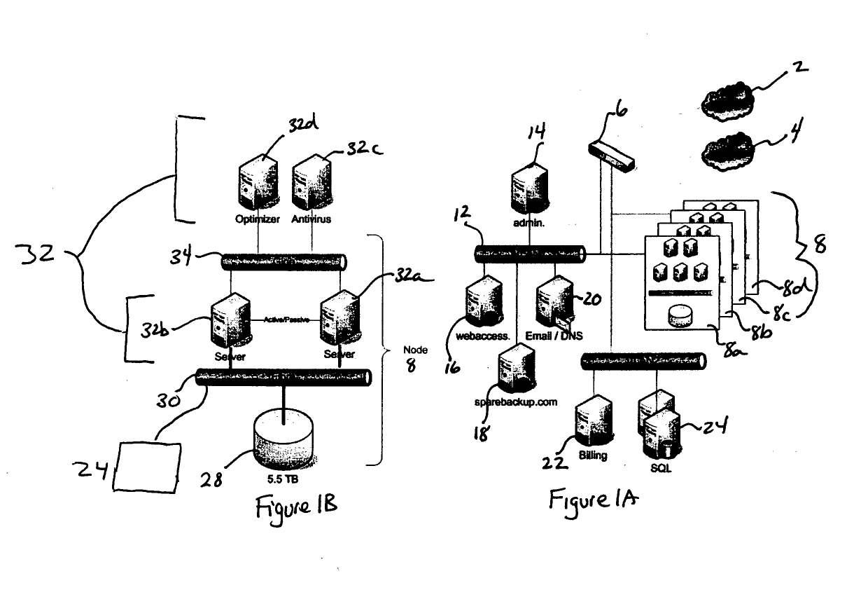

FIG. 1A illustrates a network topology comprising nodes according to an embodiment of the invention. Certain embodiments of certain elements of the node 8 may be coupled to a virtual local area network (VLAN) 12. In certain embodiments, the VLAN 12 may include servers 14-20 proprietary to a company. In certain embodiments, these servers 14-20 may be an email server 20 and/or a domain name system (DNS) server 20, a web server 16, and a spare backup server 18. Although FIG. 1A illustrates that the email/DNS server is a single physical server, in an alternative embodiment of the invention, the email server may be located on one physical device and the DNS server may be located on a separate physical device. In an embodiment of the invention, the spare backup server 18 may have a domain name address of webaccess.sparebackup.com or sparebackup.com. In embodiments of the invention, the spare backup server 18 may be hosted on one physical server. In alternative embodiments, the spare backup server 18 (or any of the other servers 14, 16, or 20) may be hosted on a plurality of servers, using techniques such as load balancing or other distributed computing techniques. In embodiments of the invention, an administration server 14 for performing administrative functions may be included as part of the VLAN 12.

In embodiments of the invention, a node 8 may be coupled to a VLAN 10, where the node includes a server 22, 24 that handles billing 22 and database 24 functions. In various embodiments of the invention, these functions may each be handled across a variety of physical computers (e.g., distributed computing) or have both the billing and database functions on one physical machine, or any other combination of servers.

In embodiments of the invention, a router 6 may be coupled to the node 8. In these embodiments, such a router 6 may allow the node 8 to communicate with a user across a communications network, such as the internet, utilizing an internet service provider (ISP) 2 and 4. In certain embodiments, the node 8 may be able to communicate with one ISP 2, or a number of ISPs 2 and 4.

FIG. 1B illustrates a node, similar to the node illustrated in FIG. 1A, according to an embodiment of the invention. In embodiments of the invention, a node may include a computer readable storage medium, such as a local disk 28. The local disk 28 may include a striped redundant array of inexpensive disks (RAID). In embodiments of the invention, the local disk 28 may have a small computer system interface (SCSI) and spin at 15,000 revolutions per minute. In embodiments of the invention, a node 8 may have 5.5 terabytes of storage capacity. In embodiments of the invention, a local disk 28 may be coupled to the rest of a node 8 over a fibre connection 30. In embodiments of the invention, the fibre connection 30 may couple the local disk 28 to the network beyond the node 8. In embodiments of the invention, a fibre connection 30 may couple the local disk 28, the user, or both to a server 32. In embodiments of the invention, a server 32 may include Dual Xeon® brand processors from the Intel Corporation clocked at over 3 gigahertz (GHz). In embodiments of the invention, a server 32 may further include 6 gigabytes (GB) of random access memory (RAM). In embodiments of the invention, two servers 32a, 32b, may be coupled by a dedicated gigabit ethernet (GIGE) connection 34. In embodiments of the invention, a server 32 may include two dedicated network interface cards (NIC), where the first is used for data and the second is for network synchronization (i.e. a heartbeat). The two servers 32a and 32b may be identical servers 32a, 32b. The GIGE connection 34 may couple to an antivirus program on a server 32c, such that the antivirus program is able to perform an antivirus scan on data transferred across the GIGE connection 34. In embodiments of the invention, an optimization program (optimizer) may reside on a server 32d such that the optimizer may optimize data that crosses the GIGE connection 34.

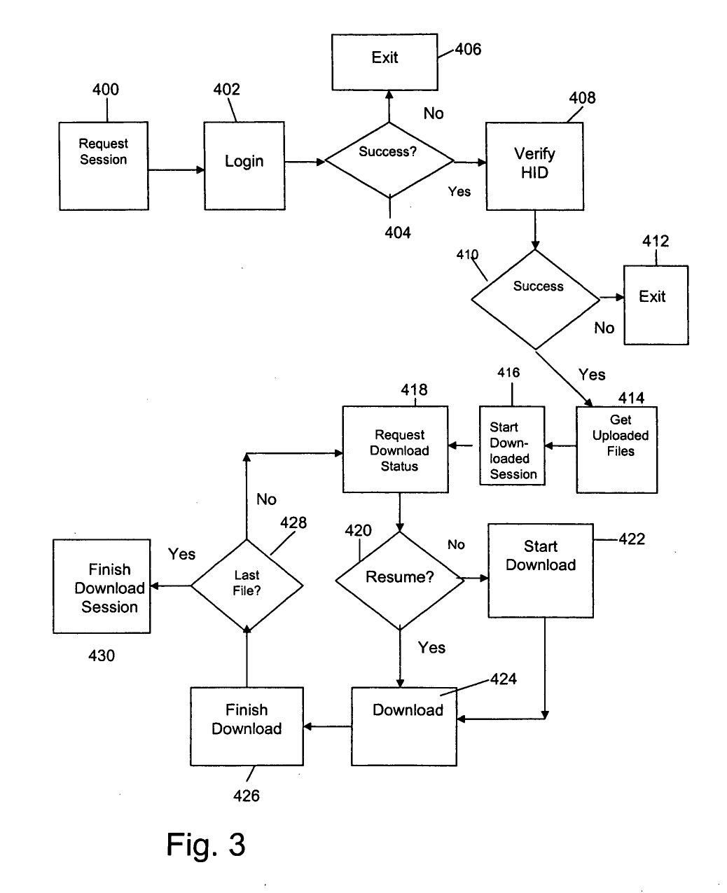

FIG. 3 illustrates a flowchart of a method to upload a file according to an embodiment of the invention. Initially, a user on a client computer uses client side software (client) to request the start of a session 300. Under certain operating conditions, the client-side software may call a request session function or subroutine. The request is a request to initiate a session for backing up specific software on the client computer. A server 32 may use a simple object access protocol (SOAP) to handle requests for TCP/IP connections on Port 80. Illustratively, the client computer may send a specific character, such as a null character (NULL, e.g. American Standards Committee on Information Interchange (ASCII) character 0). Upon receipt of the specific character, a database 24 may be queried for an assigned node 8. In an embodiment of the invention, the database 24 may be on the same physical device as the local disk 28. The local disk may also be referred to as the attached storage. In an alternative embodiment of the invention, the database 24 may be on a separate physical device from the local disk 28. In certain instances, the client computer may be redirected to a new node 8, for example, when a change has been made. In an embodiment of the invention, the client computer may be assigned a unique session key for this session if the request for a session was successful. If the request for a session is not successful, the server 32 may transmit a failure. In embodiments of the invention, a server 32 may receive and transmit encrypted messages, such as a 256 bit cipher block chaining mode on the advanced encryption standard (AES), e.g., such as the Rijndael encryption scheme.

In an embodiment of the invention, the client computer may next display a Login prompt 302. Under certain operating conditions, the client side software may call a login function. The client computer may send an email address and a spare encryption key when calling the login function. In embodiments of the invention, the database 24 may be queried to determine if this login effort is a success 304. In embodiments of the invention, the database 24 may be queried for a user account that matches this email/spare authentication key combination. If the login information cannot be verified, the user may be notified, and the upload process may exit 306. In embodiments of the invention, a process may exit 306 after only one incorrect login attempt. In embodiments of the invention, the process may have a higher limit, such as 3 attempts. Under certain operating conditions, a user may be allowed to continually resend authentication combinations, such that a process may not include an Exit 306 step.

In embodiments of the invention, the user of the client computer may be notified that their login 302 has been successful, and the uploading process may then proceed to Verify Hardware Identification (HID) 308. Under certain operating conditions, the client-side software may call a Verify HID function. In embodiments of the invention, the HID may include, for example, a unique identifier from a computer chip, certain information about a system (e.g. type of network card, processor, hard disk drive on the client computer), a number from a hardware dongle, or other information capable of identifying the hardware of the client computer. In embodiments of the invention, if the hardware verification is transmitted, a database may be queried 310 for an associated computer, e.g. a computer matching the HID. In certain embodiments, no associated computer may exist. If no associated computer exists, then the uploading process may end 312. In an embodiment of the invention, if a single associated computer license may be associated with the HID, a single computer identification (CID) may be returned from the database to the server computer 32 to the client computer. In alternative embodiments of the invention, a multiple-user-associated computer license may be associated with the HID in the database, and a list of available multiple-user-associated computer licenses/CID combinations may be returned from the database to the server computer to the client computer.

In embodiments of the invention, the CID may be returned to the client computer, such that the client computer may proceed to start 314 an upload session or a backup session. Under certain operating conditions, the client computer may call a start upload session function to initiate the actual uploading of data. In embodiments of the invention, the client computer may send a specific character, e.g., a NULL character, and the server 32 may receive the character (or the calling of the function) and update a database's history. Illustratively, the database may update statistics regarding the current upload, e.g., the time of the upload. After the upload session has been started, the client-side software of the client computer may be notified as to whether or not this start operation was successful.

The client-side software on the client computer may proceed to determining 316 upload status. Under certain operating conditions, the client side software may call an upload status function or subroutine. In embodiments of the invention, the upload status call may be used for resuming incomplete uploads. Under these operating conditions, the client computer may send a specific character, e.g. a NULL character, to the server 32 and the server may receive the character. The server 32 may query a database to determine if there is an upload that has been stopped or is incomplete for any reason. If there is an upload that has been stopped or is incomplete, then the server 32 may return to the client computer a file identification (e.g. a file identifier, a unique file handle, or similar method) and a count of how many parts of the file have been uploaded.

After the upload status has been determined, an uploading may resume by starting 318 the upload. In embodiments of the invention, where there is an upload that has already occurred (e.g., a title or unique file handle has been sent to the client computer), the uploading process may proceed to initiating uploading 322 from the client computer starting at a place indicated by the title indicator or the unique file handle that was provided during the upload status process. If there was not a current uploading process, the uploading process may proceed to start at the beginning of the files to be uploaded 320. Under certain operating conditions, a start upload function or subroutine may be called. In embodiments of the invention, the starting 320 of the uploading process may begin with a client computer sending a file name, directory, hash of the file, and the size of the original file to the server. Under certain operating conditions, this file may be referred to as a configuration file. In embodiments of the invention, a server 32 may query a database for a file matching the characteristics identified in the configuration file. In embodiments of the invention, if the file is found (e.g., exists), a flag may be set. Then, the server may return an existing file ID. In these embodiments of the invention, if the client computer receives the existing file ID, the client computer skips uploading of the file corresponding to the existing file ID, because the identified file has been determined to already exist on the server 32 and also on the database.

In embodiments of the invention, if the file is not located in the database, a server 32 may create a database entry, or database entries, and then return a file identification to the client computer. In certain embodiments, a client computer may then proceed to initiating 322 the upload process.

In embodiments of the invention, files to be uploaded may be separated into a number of parts. A determination may be made based on the size of the files to be uploaded along with the uploading speed of the client computer. For example, the client computer may divide up all files over a threshold size, e.g., 0.5 MB, 1 MB, or 2 MB, into file parts. In these embodiments, an uploading step may begin 322 when the client computer creates file parts from the file to be uploaded. In alternative embodiments, the client computer may have previously separated the file to be uploaded into file parts before beginning the uploading step. In embodiments of the invention, the uploading step may proceed 322 when the client computer sends a file name of the file and the file, or a file part name of the file and the file part (if the file has been divided into file parts). Under certain operating conditions, the client-side software on the client computer may call the upload function or upload routine. In embodiments of the invention, the file part of the file to be uploaded may be sent as a direct internet message encapsulation (DIME) attachment. In other embodiments of the invention, the file part may be sent as a Message Transmission Optimization Mechanism (MTOM) attachment or a Multipurpose Internet Mail Extensions (MIME) attachment. In embodiments of the invention, a server 32 may save the file part of the file to be uploaded (or the file) to the user's upload folder on the attached storage 28. In embodiments of the invention, a server 32 may transmit a message to the client computer to notify a user as to whether or not the storage of the file or the file part has been successful.

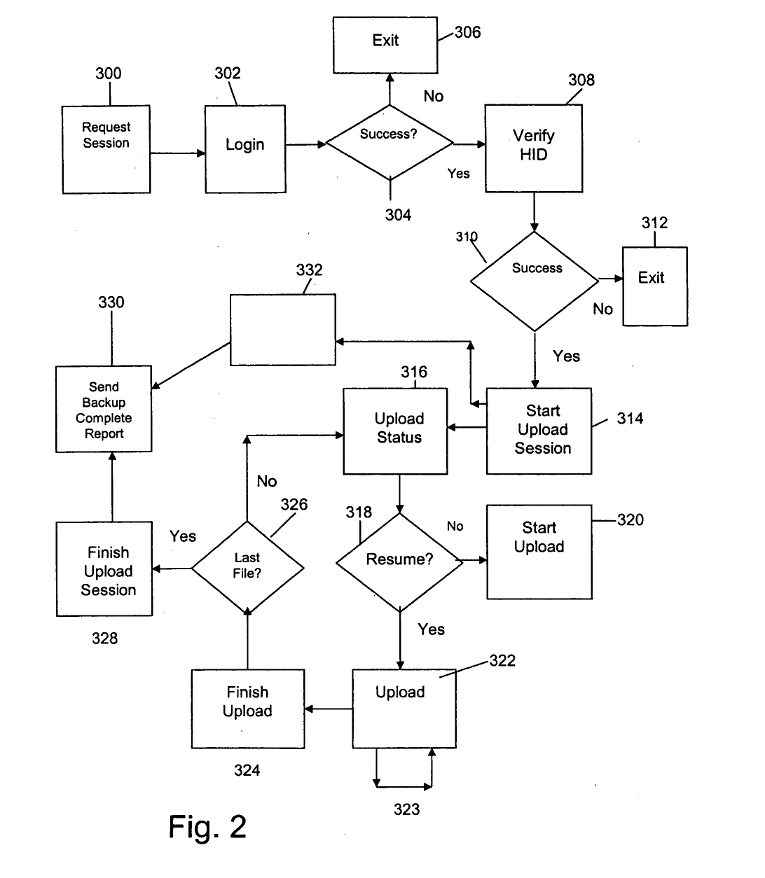

If there are multiple parts of a file to be uploaded, then the client-side software on the client computer may call the upload function or upload routine for the next file part. The calling or the upload function or the upload routine is continued until the last file part has been uploaded. This is represented in FIG. 2 by the arrow 323.

If the file has been divided into file parts, then the client-side software continues to send the file parts (or call the upload routine) for each of the file parts. Illustratively, the client-side software sends the part file name and the part file for each of the file parts in succession. For example, if the file has been divided into four parts, each of the file parts will have a file part name, e.g., filepart1, filepart2, filepart3, and filepart4. Filepart 1 is first uploaded, then filepart2, filepart3, and then filepart 4. In each of these cases, the file or the filepart is loaded into the upload file on the attached storage.

In embodiments of the invention, the uploading process for the file or the file part may finish or be completed 324. The client-side software may call the finish upload function. The client computer may send a file identification, and maybe a list of preset identifications to the server 32. In embodiments of the invention, if a number of file parts were uploaded, then the server 32 may merge the file parts of the designated file to create a copy of the original designated file. In embodiments of the invention, the original designated file may be compressed (e.g., utilizing the zip compression algorithm) and/or encrypted (e.g. in the Rijndael encryption format). In certain embodiments, the server 32 may then copy the new designated file (e.g., the uploaded file), which can be uncompressed, compressed, encrypted, or compressed and encrypted to the user's folder on the attached storage 28. In other words, the uploaded file is moved from the upload folder to the user folder. In embodiments of the invention, the server 32 may then update the database to identify that the designated file (uploaded file) has been copied. In embodiments of the invention, the server 32 may notify the client computer as to whether or not these operations were successful.

Under certain operating conditions, the designated file or uploaded file may be flagged for virus scan. This is utilized to prevent a user from loading an infected file to the server or database and infecting the central server or database file. Under certain operating conditions, the designated file or uploaded file may also be flagged for optimization. Optimization may be utilized to reduce the size of multi-version storage scenarios. Under certain operating conditions, the designated file or uploaded file may have presets associated with the file. Under certain operating conditions, the server may send a message identifying success or failure to the client-side computer.

In embodiments of the invention, a server 32 may determine 326 if the last file of the client computer's upload group has been uploaded. In an embodiment of the invention, the client computer may identify that the last file has been uploaded by calling a finish upload function or subroutine. In an embodiment of the invention, a user of the client computer may be queried for this information. In an embodiment of the invention, the client computer may provide the server 32 with a list of files, such that the server 32 can determine whether the last file of the client computer's upload group has been uploaded. If there are more files of the client computer's upload group to upload, then the process may return to step 314 (the start upload session step) and repeat the process as described above. If the server 32 determines 326 that the last file of the client computer upload group has been uploaded, then the upload process may be finished 328.

In embodiments of the invention, the upload process may be finished where a client sends an ending character, such as a NULL character (or by calling the finish upload function or subroutine). The client-side computer may call the finish upload time or finish upload function. In embodiments of the invention, a server 32 may respond to receipt of the ending character by updating the history of the database. For example, when the finish upload function is called, the server 32 may update the database with an upload time (which is the time the upload of the file is finished). When the finish upload session function is called, the server may update the database with a session finish time, which is the time when the session is finished (e.g., all of the-uploaded files). The server 32 may also notify the client as to whether or not the updating of the history was successful.

In embodiments of the invention, the upload process may send 330 a backup complete report to the client computer. In embodiments of the invention, this may begin when the client computer sends a count of files, a count of skipped files (e.g. there was already a copy on a server 32), and a list of file identifications for the files that were skipped. The client computer may need to provide the server with information regarding files that were skipped, (e.g., because they were corrupt, locked, opened, etc.) because the server is not aware of these files. Illustratively, a client computer may send a hypertext transport protocol (HTTP) request to reports.sparebackup.com server 18 (i.e., Domain Name System number 69.13.42.109 as of Aug. 9, 2005), which uses Microsoft's ASP.NET® to generate reports. In embodiments of the invention, the server 18 may receive data from a client embedded in the requested uniform resource locator (URL). In an embodiment of the invention, the server computer then generates the report including the information regarding the skipped files that the client computer provided to the server computer. Under certain operating conditions, the server may transmit the report to the client computer. In embodiments of the invention, a server 18 may return to the client whether or not the report generation has been successful.

In another embodiment of the invention, a client computer may be configured or programmed to perform a quick upload of a client computer. A quick upload may be utilized if the file is small enough that the file to be uploaded does not have to be broken into parts. Illustratively, this may be the case if only a small number of small files (of small size) are to be uploaded. In this embodiment of the invention, the client-side software on the client computer may proceed from Start Upload Session 314 to Quick Upload 332. Under other operating conditions, a quick upload function or subroutine is called. In this embodiment of the invention, the quick upload may occur only if a user requests it via a user interface of the client computer. In a quick upload, the client computer sends a file identification, a file name, a preset list and a file (e.g. a DIME attachment). This may be referred to as the quick upload configuration file. In embodiments of the invention, a server 32 may save the quick upload configuration file to the user's folder in the attached storage 28. In certain embodiments, a server 32 may then update the history of the database. In embodiments of the invention, the updating of the database may proceed in a similar fashion to the database updating disclosed in step 320 above. In embodiments of the invention, a server 32 may notify the client computer as to whether or not the sending of the quick upload configuration file and the updating operation was successful. In embodiments of the invention, a report may be generated which is called the “send backup complete report” 330. In this embodiment of the invention, after the quick upload is complete, the server computer may generate and send 330 the backup complete report.

FIG. 3 illustrates a download process according to an embodiment of the invention. In an embodiment of the invention, steps 400-412 may be performed in the same fashion as steps 300-312 described above in relation to the upload process. In embodiments of the invention, the server side software on the same server 32 may implement both the download process and the upload process, e.g., both the upload process and the download process share resources.

In embodiments of the invention, the download process may get or retrieve 414 the files which have been previously uploaded, e.g., perform a get uploaded files function. In this step, a server 32 may receive a restore data request from the client computer. The server 32 may access the database 24 and query the database 24 for files that were uploaded prior to the restore date (which may also be provided by client-side software on the client computer with the restore data request). The server may create a two dimensional array of files and include a file ID, a file directory, and a file hash. The two dimensional array is flattened and then transmitted to the client computer. This may be referred to as a selected list of files. In embodiments of the invention, the client computer can retrieve the user's stored files more quickly than if the files were not retrieved from the attached storage 28 until after the client had requested them.

In embodiments of the invention, the selected list of files may be returned to a client computer. In an embodiment of the invention, the client computer may proceed to downloading 416 a stored selected group of files. In embodiments of the invention, the client computer may send a specific character, e.g., a NULL character, the server 32 may receive the specified character, and the server 32 may update a database's history. Illustratively, the history may be updated with a time that the download has started. In embodiments of the invention, the client computer may be notified that the database has been updated.

In embodiments of the invention, the client computer may proceed to a download status step 418. In embodiments of the invention, the download status step 418 may be used for resuming incomplete downloads. In an embodiment of the invention, a client may send a specific character, e.g., a NULL character. Under certain operating conditions, the client-side software may call a download status function or routine. In response to the receiving of the specific character or the download function being called, a server 32 may query the database to determine if there is a current download that was interrupted. If the current download was interrupted, the server 32 may return to the client computer a file identification (e.g. a title or unique file handle) and a count of how many parts of the file have been downloaded.

In this embodiment of the invention, a client computer may resume 420 the incomplete or interrupted download. In embodiments of the invention described above where there is a current download, the download process may proceed directly to downloading 424 the next file in the selected list of files that were in the download request that was interrupted. Otherwise, in embodiments of the invention where there is no current download in process, the downloading process may be initiated 422. In an embodiment of the invention, the downloading step 422 may begin with the client-side software on client computer sending a file name, a directory, hash of the file, and a size of the original file, which may be referred to as the download configuration file. In alternative embodiments of the invention, a server 32 may query the database to determine if a file exists that matches or corresponds to the download configuration file. In this embodiment of the invention, if the file corresponding to the download configuration file is determined to exist in the database, a download configuration file exists flag may be set, and the file identification may be returned to the client computer. In embodiments of the invention, the client computer may then skip downloading the download configuration file, because it has been determined that this download configuration file already exists on storage accessible by the client, e.g., like the client computer hard drive or removable drive, at the same location that the client wants to download the file to. Under certain operating conditions, the file may only be skipped if the file has the same hash value, e.g., hash (MD5) check match. If the file is to be skipped, the process moves to determining where the last file has been downloaded, e.g., step 428, which is discussed below.

In embodiments of the invention, if the file corresponding to the download configuration file is not located, a server 32 may create a database entry, or entries, and return the file identification to the client computer. In this embodiment of the invention, the client computer may then proceed to starting the downloading 424 of selected files.

In an embodiment of the invention, the starting of the downloading may occur when the client-side software of the client computer sends a file ID to the server 32. Under certain operating conditions, the client-side software on the client computer may also send a file part size or a threshold for a maximum size for a file part size. The server 32, as noted above, is queried for the file. After the file is retrieved, the file is split into parts based on the file size, a file parts count is created, and transferred to the user's download folder on the attached storage. Under other operating conditions, the files may be pre-divided into file parts based on a spare backup system file threshold size. The database history may also be updated. The file part count may be returned to the client computer. Illustratively, if a file has three file parts, the server-side software divides up the file stored in the user account into three files and stores the three file parts into the user's download file on the server or database.

In embodiments of the invention, the downloading step 424 may proceed when a client computer transmits a file part name, or the file part itself. Under certain operating conditions, the client-side software on the client computer may call the download function or subroutine. In response to the call of the download function, the server may move the part of the stored file from the user's download folder on the attached storage to the user's download part folder on the attached storage. In an embodiment of the invention, the server also generates a response to the client computer and may attach the part file to the response. Illustratively, the part file may be attached as a DIME attachment. Alternatively, the part file may be sent as a Message Transmission Optimization Mechanism (MTOM) attachment or a Multipurpose Internet Mail Extensions (MIME) attachment.

Alternatively, the file part (or file) is sent from the user's download part folder to designated storage on the client computer. The calling of the download function and the responding is continued until all of the file parts of a file (or the file) have been downloaded.

In embodiments of the invention, the downloading process for the file may finish 426. In other words, all of the file parts may be downloaded to the client computer. The finish step 426 may begin where the client computer sends a file identification to the server. The client-side software on the client computer may know the download of the file is completed because the number of stored file parts downloaded may be equal to the file part count. Under certain operating conditions, the client-side software on the client computer may call a finish download function or subroutine. In embodiments of the invention, the client computer may then merge the downloaded file parts to form a copy of the originally stored file. In embodiments of the invention, the copy of the stored file may be compressed (e.g. via a zip compression algorithm) and/or encrypted (e.g., a Rijndael format). In embodiments of the invention, the server 32 may be notified as to whether or not the downloading operation was successful. In embodiments of the invention, a server 32 may then update the database history to identify the copy of the stored file was downloaded and whether or not the downloading operation was successful.

In embodiments of the invention, a server 32 may then determine if the last file in the selected group of files had been downloaded 428. In embodiments of the invention, the client computer may be queried for this information. In such embodiments, the client computer may provide the server 32 with a list of files that should have been downloaded, such that the server 32 can determine whether the last file had been downloaded. If there are additional files to download, then the downloading process may return to the downloading status step 418 and repeat a process as is described above. If the server 32 determines that last file has been downloaded 428, e.g., a true condition is returned, then the downloading process may proceed to finalize 430 the downloading session.

In embodiments of the invention, the finalizing downloading step 430 may occur when the client computer sends a specific character, e.g., the NULL character. Under certain operating conditions, the client-side software on the client computer may call a finish download function or subroutine. In embodiments of the invention, the server 32 may respond to the receipt of the specific character by updating the history of the database to identify that the downloading process has been finalized. In addition, the server 32 may respond by notifying the client computer as to whether or not the finalization of the download process was successful.

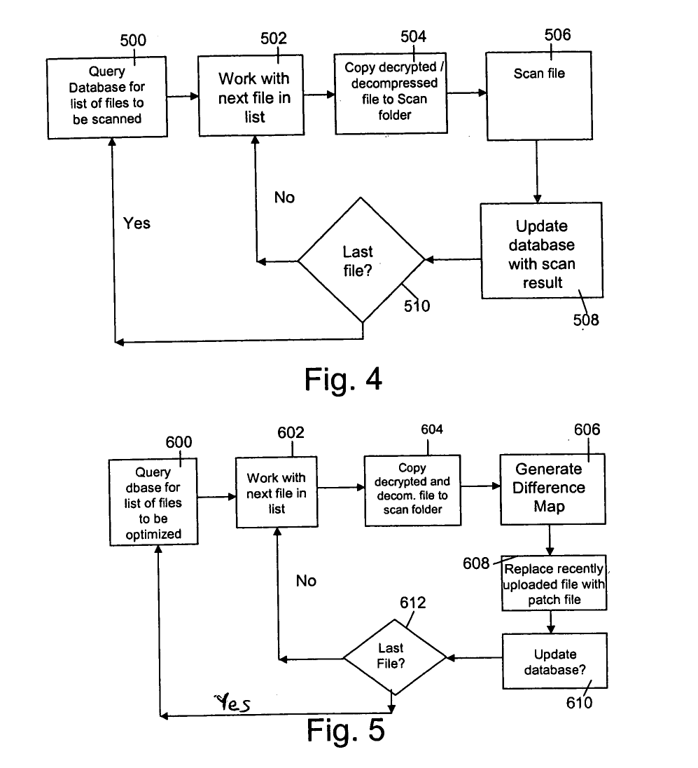

FIG. 4 illustrates a process to disinfect certain files from computer viruses according to an embodiment of the invention. In embodiments of the invention, this process may run on a fixed schedule. Illustratively, the disinfecting process may begin every 60 minutes. In embodiments of the invention, the disinfecting process schedule may be adjustable either by a system administrator or user. The disinfecting process may begin with the server 32 querying the database for a list of files that need to be scanned 500 for viruses. In embodiments of the invention the list of files is generated based on the files that have been uploaded to the server. In other words, each file that gets uploaded to the server is placed on the list to make sure it is free from viruses and is not corrupt. The list may contain only files for one client computer. The list may contain only files that are in the database. The list may contain only files that have been changed, accessed, modified or created since the previous anti-virus scan (i.e., disinfecting step). The list may include files that had not been scanned in the last anti-virus scan. In an embodiment of the invention, the list may place the oldest files first, i.e., at the begging of the disinfecting process.

In embodiments of the invention, the disinfecting process may retrieve 502 the next (or first) file in the list. The retrieving step 502 may retrieve the next file from the attached storage 28. In an embodiment of the invention, the retrieving step 502 may also include decrypting the retrieved next file. The retrieving step 502 may also include decompressing the retrieved next file. Under certain operating conditions, encryption may occur before compression or vice versa. In embodiments of the invention, the disinfecting process may copy 504 the retrieved file (after the retrieved files has been decrypted and/or decompressed) to a Scan folder. In embodiments of the invention, a server 32c may have a Scan folder, also known as a directory, of files which may be scanned for the computer virus in order to disinfect the retrieved files. In an embodiment of the invention, the Scan folder may be located in the database or in the server.

In embodiments of the invention, the disinfecting process may then scan 506 the retrieved files in the Scan folder. In embodiments of the invention, the disinfecting process may utilize a commercial anti-virus program, such as McAfee VirusScan®, to audit the retrieved file or files for possible presence of malicious or unwanted computer code. In embodiments of the invention, the server 32c may update 508 the database with the disinfecting scan result. In embodiments of the invention, the updating of the database may include modifying a log file on attached storage 28 to reflect which file (or files) were scanned, what time the disinfecting scan occurred and which virii, if any, were detected during the disinfecting scan. In embodiments of the invention, a server 32c may email a report to certain users on client computers with results of the scans. Illustratively, if client computer A had five files scanned and one of the files had a virus embedded in the file, the server may email a report to the user on client computer A identifying that one of the files had a virus and was infected. In embodiments of the invention, the user may be able to opt out of receiving such the virus report. In embodiments of the invention, the user may be able to opt in to receiving such a report. Under certain operating conditions, such a virus report may be sent once a day.

In embodiments of the invention, the server 32c may determine 510 if the last file of the files in the Scan folder has been scanned. In embodiments of the invention, the server 32c may compare the total number of files processed or scanned to the length of the list queried from the database in step 500. In an alternative embodiment of the invention, the server 32c may compare the file identification of the most recent file to the file identification of the last file on the list queried from the database. In embodiments of the invention, if the file scanned was not the last file to be scanned, the disinfecting process may proceed to scan the next file in list 502. In embodiments of the invention, if the last file has been scanned, then the disinfecting process may query the database for another list of files that are to be scanned 500. In embodiments of the invention, the disinfecting process may wait until the end of the scheduled timeframe, e.g., 60 minutes, before querying the database for list of other files that are to be scanned 500.

FIG. 5 illustrates an optimization process to optimize certain files for size, access speed or other design goals according to the embodiment of the invention. In embodiments of the invention, the optimization of certain files may reduce the size of certain multi-version files. In embodiments of the invention, the optimization process may run on a fixed schedule while in other embodiments of the invention, the optimization process may be adjustable or modifiable. Illustratively, the optimization process may begin every 60 minutes. The optimization process may begin by a server querying 600 a database for a list of files that are to be optimized. In embodiments of the invention, the list of files may only contain files corresponding to one client computer. In embodiments of the invention, the list of files to be optimized may include files that have been changed, accessed, modified or created since the previous optimization scan. In embodiments of the invention, the list of files to be optimized may include files that were not scanned during the last optimization scan. In embodiments of the invention, the list of files to be optimize may be list the oldest files first in order for these older files to be the first to be optimized.

In embodiments of the invention, the optimization process may retrieve 602 a next file (or a first file) in the list. In embodiments of the invention, the retrieval step 602 may retrieve the next file from the attached storage 28. In embodiments of the invention, the retrieval step 602 may decrypt the file after the file has been retrieved. In embodiments of the invention, the retrieval step 602 may decompress the file after the file has been retrieved. In an embodiment of the invention, decryption may happen before decompression or vice versa. In other embodiments of invention, one of decryption or decompression of the file may occur, but not the other. In an embodiment of the invention, the retrieval step may verify that the file has not been flagged to be disinfected, e.g., receive an anti-virus scan. In embodiments of the invention, the optimization process may copy 604 the retrieved file or the retrieved decrypted and decompressed file to a Scan folder 604. In embodiments of the invention, a server 32d may house a folder, which may be referred to as a scan directory, of files which may be optimized.

In embodiments of the invention, the optimization process may generate 606 a difference map. In embodiments of the invention, the generation step 606 may compare a file which has been stored and now retrieved with a later version of the file. In embodiments of the invention, the generation step 606 may generate a listing of the differences between the two files (difference map). In embodiments of the invention, the difference map may be stored as a patch file, such that the changes can be applied (or removed from) one of the files to generate the other file to which it was compared. In embodiments of the invention, the optimization process may replace 608 the file which had recently been stored with the patch file 608. In embodiments of the invention, a server 32d may copy this patch file to the client computer's folder in the attached storage.

In embodiments of the invention, a server 32d may update 610 the database. In this embodiment of the invention, the server 32d may also access a log file on the attached storage 28, and modify the log file to reflect the optimization process has been completed. In embodiments of the invention, the updating may include the file identification, the time of the optimization, the amount of optimization achieved, or other relevant information. In embodiments of the invention, the server 32d may determine 612 if file which was last optimized was the last file to be optimized. In embodiments of the invention, the server 32d can determine if the last file has been optimized by comparing the total number of files processed to the length of the list queried from the database 600. In an alternative embodiment of the invention, the server 32d may compare the file identification of the most recent file to the file identification of the last file on the list.

If the last file from the list has been optimized, then the server may query the database again for a list of files that are to be optimized 600. In embodiments of the invention, the server 32d might not initiate the optimization process until the current time period has expired. After the current time period has expired, the server may query the database for a list of files that are to be optimized 600. If the file optimized was not the last file to be optimized, then the server 32d may initiate the optimization of the next file in the list 602.

Under different operating conditions, the server 32 (sometimes referred to as the Spare Backup Server) may accept connections from the client computers (includes WebAccess connection) and may receive files from the client computer. The server 32 may send files to the client computer; may update the database with file information; and may execute various report and administration functions requested by the client computer.

When a new user is to be added to the spare backup system, the new user may enroll utilizing a client computer. The new user may transmit a request to the server. Included in the new account request may be a subscription code, an email, a password, a phone number, a first name, a last name, an address, a city, a state, or a zip code. The new account request may also include a country of residence and answers to escrow questions. Illustratively, the user may enroll by logging onto sparebackup.com.

In response to the new user request, database entries may be created for the new account in the database 24. The server may create user folders for the new user on the attached storage 28. The server 32 may also transmit a welcome email to the new user. Illustratively, the welcome email may include the email, the password, and a spare key, which may be utilized to access the spare backup system. The server 32 may also transmit a notification as to whether or not the enrollment was successful. If the new user desires a new spare key, the client computer may send a new spare key request and during the opening of the next session, the new spare key may be returned.

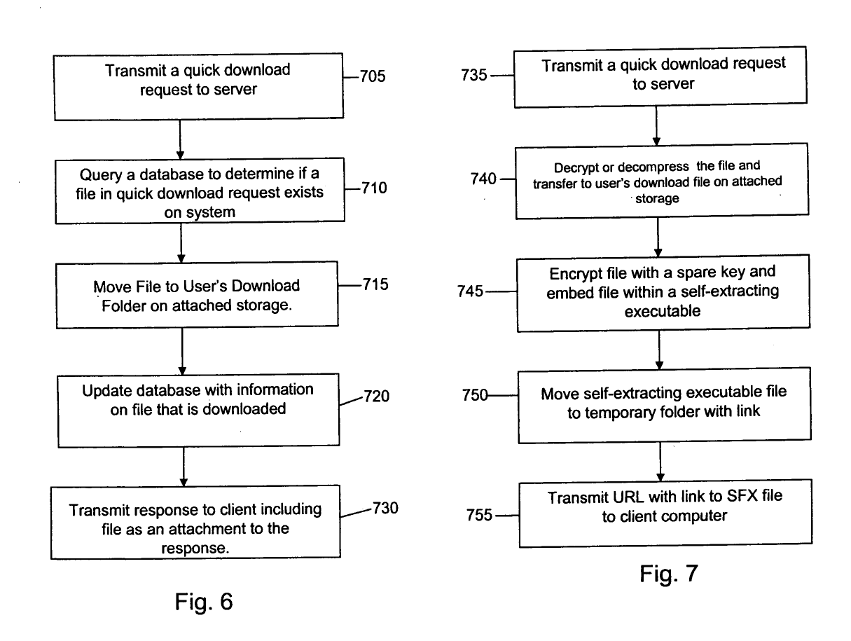

FIG. 6 illustrates a quick download request according to an embodiment of the invention. In an embodiment of the invention, a quick download process may be utilized by the user. In an embodiment of the invention, the client-side software on the client computer may transmit 705 a quick download request. In the quick download request, the client-side software may include a file ID of the file to be downloaded. In response to the quick download request, the server 32 may query 710 the database 24 to determine if the database or the user attached storage has a copy of the file corresponding to the file ID. If the file exists, then the file is moved to the user's download folder 715 on the attached storage. After the file has been moved to the user's download folder, the database 24 may be updated 720 with information such as what file has been downloaded, at what time, and how many times has it been downloaded. A response is then transmitted 725 to the client computer and the file is attached to the response. Illustratively, the file may be a DIME attachment attached to the response. Alternatively, the file may be sent as a Message Transmission Optimization Mechanism (MTOM) attachment or a Multipurpose Internet Mail Extensions (MIME) attachment.

FIG. 7 illustrates creating a self-extracting executable for download according to an embodiment of the present invention. Alternatively, the spare backup system may create a self-extracting executable for the quick download process. The client-side software on the client computer may transmit 735 a quick download request to the server 32. In the quick download request, the client-side software may include a user ID, a hardware identification, a file ID, a file name, and a spare key. The server 32 receives the quick download request and, utilizing the included information, retrieves the file from the user attached storage, decrypts the file, and decompresses the file. The decrypted and decompressed file is transferred 740 to the user's download folder on the attached storage 28. The decrypted and decompressed file is then encrypted 745 with the spare key and embedded within a self-extracting executable. The file may then be referred to as a SFX file. The SFX file may be moved 750 to a temporary folder on the spare backup system website. The server 32 may transmit 755 a URL for the SFX file to the client computer.

The Spare Backup Server program may include one 32-bit Windows™ Web Service, and three 32-bit Windows™ Services. The Spare Backup Server program may be hosted on a Windows Server.

Requirements

Two Identical Servers Per Node

1. Windows Server 2003 Enterprise
2. Active/Passive cluster
3. Fibre HBA
4. GIGE NIC×2
   a. Dedicated GIGE NIC for Network
   b. Dedicated GIGE NIC for Heartbeat
      i. Cross-over cable
5. Dual Xeon Processors @ 3 GHz+
6. 6 GB RAM+
7. SCSI 15K RAID (striped) local disk access
   a. Paging
   b. Logging

Workflow
1. Listens on Port 80 for TCP/IP connections from Client
   a. SOAP protocol
2. Accepts connection request form Client

Security
1. Request Session
   a. Client sends: NULL
   b. Database is queried for assigned Node
      i. Client is redirected to new Node if a change has been made
   c: Client is assigned a unique Session Key for the Session
      i. The Session Key is used to encrypt/decrypt incoming/outgoing SOAP messages for the remainder of the Session (AES Rijndael 256-bit CBC)
2. Login
   a. Client sends:
      i. Email
      ii. Spare Key
   b. Database is queried for User Account
   c. Login information is verified
   d. Success/Failure is returned to Client
3. VerifyHID
   a. Client sends: Hardware Identification (HID)
   b. Database is queried for associated Computer
      i. Computer Alias (CA) exists: Computer Identification (CID) is returned
      ii. Single CA license: HID is associated with CID, CID is returned
      iii. Multi CA license: List of available CA/CID is returned

New User
1. New User
   a. Client sends:
      i. Subscription Code
      ii. Email
      iii. Password
      iv. Phone
      v. First Name
      vi. Last Name
      vii. Address
      viii. City
      ix. State
      x. Postal
      xi. Country
      xii. Escrow Q&A
   b. Database entries are created for new account
   c. User folders are created on attached storage
   d. Welcome email is sent to user
      i. Email
      ii. Password
      iii. Spare Key
   e. Success/Failure is returned to Client
2. New User Spare Key
   a. Client sends: NULL
   b. Spare Key (stored in Session) is returned

Upload
1. Start Upload Session
   a. Client sends: NULL
   b. Database is updated: History
   c. Success/Failure is returned to Client
2. Upload Status (used for resuming incomplete uploads)
   a. Client sends: NULL
   b. File ID and Part Count (uploaded) of current file (if any) is returned
3. Start Upload
   a. Client sends:
      i. File Name
      ii. File Directory
      iii. File Hash
      iv. Original File Size
   b. Database is queried for existing file
      i. File Exists flag and existing File ID is returned to client if the file already exists
         1. Client skips file
   c. Database entries are created
   d. New File ID is returned to Client
4. Upload
   a. Client sends:
      i. Part File Name
      ii. Part File (DIME attachment)
   b. Part File is saved to users Upload Folder on the attached storage
   c. Success/Failure is returned to Client
5. Finish Upload
   a. Client sends:
      i. File ID
      ii. Preset List (list of Preset IDs associated with file)
   b. File Parts are merged to form the original compressed and encrypted file
   c. File is moved to user's Folder on the attached storage
   d. Database is updated
      i. New files are flagged for Virus Scan
      ii. Version 2+ files are flagged for Optimization
      iii. Presets are associated with the file
   e. Success/Failure is returned to Client
6. Finish Upload Session
   a. Client sends: NULL
   b. Database is updated: History
   c. Success/Failure is returned to Client
7. Send Backup Complete Report
   a. Client sends:
      i. File Count
      ii. Skipped File Count
      iii. Skipped Files (list of File IDs)
   b. HTTP request for report is sent to reports.sparebackup.com (ASP.NET website responsible for generating reports)
      i. Information received from Client is sent within the request URL
   c. Success/Failure is returned to Client
1. Quick Upload (used for whole file uploads; replaces: Upload Status, Start Upload, Upload, Finish Upload)
   a. Client sends:
      i. File ID
      ii. File Name
      iii. Preset List
      iv. File (DIME attachment)
   b. Attached File is saved to user's Folder on the attached storage
   c. Database is updated: see Start Upload
   d. Success/Failure is returned to Client
2. Update File Presets
   a. Client sends:
      i. File ID
      ii. Preset List (list of Preset IDs associated with file)
   b. Database is updated: Presets are associated with the file
   c. Success/Failure is returned to Client
3. Save Client Log
   a. Client sends: encrypted Computer debug log
   b. Database is updated: Client Logs
   c. Success/Failure is returned to Client

Download
1. Get Uploaded Files
   a. Client sends: Restore Date
   b. Database is queried for files uploaded prior to the Restore Date
   c. Two dimensional array of files is created:
      i. File ID
      ii. File Directory
      iii. File Hash
   d. Array is flattened and returned to Client
2. Start Download Session
   a. Client sends: NULL
   b. Database is updated: History
3. Download Status
   a. Client sends: NULL
   b. File ID and Part Count (remaining) of current file (if any) is returned
4. Start Download
   a. Client sends:
      i. File ID
      ii. Part Size (requested)
   b. Database is queried for File
   c. File copy is Split into parts (reference: 4.a.ii) into user's Download folder on attached storage
   d. Database is updated: History
   e. Part Count is returned to Client
5. Download
   a. Client sends: Part File Name
   b. Part File is moved to user's Download Part folder on attached storage
   c. Part File is attached to response to Client (DIME attachment)
6. Finish Download
   a. Client sends: File ID
   b. Database is updated: History
7. Finish Download Session
   a. Client sends: NULL
   b. Database is updated: History
1. Quick Download (used for whole file downloads; replaces: Download Status, Start Download, Download, Finish Download)
   a. Client sends: File ID
   b. Database is queried for File
   c. File is moved to user's Download Part folder on attached storage
   d. Database is updated: History
   e. File is attached to response to Client (DIME attachment)
2. MakeSFX
   a. Client sends:
      i. User ID
      ii. CID
      iii. File ID
      iv. File Name
      v. Spare Key
   b. File is decrypted and decompressed into user's Download folder on attached storage
   c. File is encrypted with Spare Key (AES Rijndael 256-bit CBC) and imbedded within a self-extracting executable (SFX).
   d. SFX file is moved to temporary public folder on IIS6 website
   e. URL to SFX file is returned to Client

Upload Process
1. Client calls: RequestSession( )
   Returns: Success or Failure
2. Client calls: Login(UserName, SpareKey)
   Returns: Success or Failure
3. Client calls: VerifyHID(HID)
   Returns: CID, CID List, or Failure
4. Client calls: StartUploadSession( )
   Returns: Success or Failure
5. Client calls: UploadStatus( )
   Returns: CurrentFileID, PartCount
   a. If CurrentFilefD=NULL Then
      i. Goto Step 6
   b. Else
      i. Goto Step 7
6. Client calls: StartUpload(FileName, Directory, Hash, OfflineSize)
   Returns: New File ID, File Exists+File ID, or Failure
   a. If FileExists Then
      i. Store File ID & Skip File
   b. Else Goto Step 7
7. Client calls: Upload(PartFileName)
   Returns: Success or Failure
   a. Note: PartFileName=*.(PartCount)
8. Client calls: FinishUpload(FileID, PresetList)
   Returns: Success or Failure
9. Client calls: FinishUploadSession( )
   Returns: Success or Failure

Quick Upload Process

For files that do not need to be split. This is determined by the Client, based on the file Part Size. If the file is <=Part Size, the Client uses Quick Upload. The Part Size is determined based on the user's upload speed (a value which is dynamically set after each file upload).
1. StartUpload(See: Upload Process)
2. QuickUpload(FileID, FileName, PresetList)
   Returns: Success or Failure

Download Process
1. Client calls: RequestSession( )
   Returns: Success or Failure
2. Client calls: Login(UserName, Password, SpareKey)
   Returns: Success or Failure
3. Client calls: VerifyHID(HID)
   Returns: CID, CID List, or Failure
4. Client calls: StartDownloadSession( )
   Returns: Success or Failure
5. Client calls: DownloadStatus( )
   Returns: CurrentFileID, PartCount, or Failure
   a. If CurrentFileID=NULL Then
      i. Goto Step 6
   b. Else
      i. Goto Step 7
6. Client calls: StartDownload(FileID, PartSize)
   Returns: PartCount, or Failure
   a. If UnknownFile Then
      ii. Skip File
   b. Else Goto Step 7
7. Client calls: Download(partFileNaine)
   Returns: Success (with DIME attachment) or Failure
   a. Note: PartFileName=FileID.(PartCount)
8. Client calls: FinishDownload(FileID)
   Returns: Success or Failure
9. Client calls: FinishDownloadSession( )
   Returns: Success or Failure

Quick Download Process

For files that do not need to be split. This is determined by the Client, based on the file Part Size. If the file is <=Part Size, the Client uses Quick Download. The Part Size is determined based on the user's download speed (a value which is dynamically set after each file download).
1. StartDownload(See: Download Process)
2. QuickDownload(FileID)
   Returns: Success or Failure

Sync Process
1. Sync/Client calls: RequestSession
   Returns: Success or Failure
2. Sync/Client calls: Login(UserName, SpareKey)
   Returns: Success or Failure
3. Client calls: VerifyHID(HID)
   Returns: CID, CID List, or Failure
   a. Sync Client calls: VerifySyncHID(HID)
   Returns: CID, CID List, or Failure
4. Sync/Client calls: StartSyncSession( )
   Returns: Success or Failure

Upload
1. Sync/Client calls: SyncUploadList(clientFiles)
   a. Server checks each clientFile Hash by ID:
      i. Existing Hash: file is removed from list
      ii. New Hash: file remains in list.
   b. Returns: list of file IDs to Upload
2. Sync/Client calls: UploadStatus( )
   Returns: CurrentFileID, PartCount
   a. If CurrentFileID==NULL Then
      i. Goto Step 3
   b. Else
      ii. Goto Step 4
3. Sync/Client calls: StartSyncUpload(ID, Hash, OfflineSize)
   Returns: New File ID, Unknown File, File Synced, or Failure
   a. If FileExists Then
      i. Store File ID & Skip File
   b. Else Goto Step 4
4. Sync/Client calls: Upload(PartFileName)
   Returns: Success or Failure
   a. Note: PartFileName=*.(PartCount)
5. Sync/Client calls: FinishUpload(FileID, PresetList)
   Returns: Success or Failure

Download
1. Sync/Client calls: SyncDownloadList(clientFiles)
   a. Server builds a list of Synced file IDs/Hashes to download (serverFiles)
   b. Server compares clientFiles list to serverFiles list
      i. Existing Hash: file is removed from list
      ii. New Hash: file remains in list
   c. Returns: list of file IDs to Download
2. Sync/Client calls: DownloadStatus( )
   Returns: CurrentFileID, PartCount, or Failure
   a. If CurrentFileID==NULL Then
      i. Goto Step 3
   b. Else
      i. Goto Step 4
3. Sync/Client calls: StartDownload(FileID, PartSize)
   Returns: PartCount, or Failure
   a. If UnknownFile Then
      i. Skip File
   b. Else Goto Step 4
4. Sync/Client calls: Download(partFileName)
   Returns: Success (with DIME attachment) or Failure
   a. Note: PartFileName=FileID.(PartCount)
5. Sync/Client calls: FinishDownload(FileID)
   Returns: Success or Failure
6. Sync/Client calls: FinishSyncSession( )
   Returns: Success or Failure

Deployment
1. Install IIS6 w/ ASP.NET
2. Install Microsoft WSE 2.0 SP3 (runtime)
3. Copy run-time files for SpareServer web service to website folder
4. Copy UberCrypto.dll to % System32% folder and register
5. Copy UberSplitter.dll to % System32% folder and register

Spare Antivirus

Responsible for disinfecting newly uploaded files via a commercial Antivirus product (McAfee Antivirus); placing infected files in quarantine; updating database.
1. Runs every hour (adjustable)
2. Queries database for list of files flagged for Virus Scan (oldest first)
3. Scans files
4. Infected files are flagged for Quarantine
5. Updates database
6. Includes results in Daily Report e-mailed to user
   a. If user has opted-out of daily report, report is sent containing Quarantined file information, only.

Spare Optimizer

Responsible for reducing the size of multi-version file storage scenarios.
1. Runs every hour (adjustable)
2. Queries database for list of files flagged for Optimization (oldest first)
   a. Requires Virus Scan (flag=false)
3. Optimizes files
   a. Difference Map is generated using New file and Original file
   b. Patch is saved to user's folder
   c. New file is deleted
4. Updates database

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated.

What is claimed is:

1. A method for storing data at a remote location, the method comprising the steps of:
initiating a communication session between a server and a client system;
logging on the client system using identity and password information; and
storing data retrieved from the client system at the server in a remote location.

2. A system for storing data at a remote location, the system comprising:
a client computer;
a server system at a remote location to store data on an attached storage which originally resided on the client computer; and
a network coupling the client computer to the server system, wherein the client computer initiates a communication session between the client computer and the server system and logs onto the server utilizing identity and password information.

3. A method for storing data at a remote location, including:
receiving a request to start an upload session and transmitting a session key to a client computer;
receiving a logon request from a user and transmitting contents of the logon request to a database to verify the user's logon is authentic;
receiving a hardware identification from the client computer and transmitting the hardware identification to the database to verify the client computer is authentic;
receiving a start upload request from the client computer and updating an upload history for the client computer;
receiving an upload command from the client computer including a file name and sending a file identification to the client computer, the file identification corresponding to the file name; receiving a file corresponding to the file name from the client computer and transferring the file to an attached storage; and
receiving a finish upload command from the client computer and transmitting an indicator to the attached storage to indicate that the finish upload command has been received.

4. The method of claim 3, further including flagging the received file for virus scan to prevent an infected file from being stored in the attached storage.

5. The method of claim 3, further including flagging the received file for optimization to reduce storage requirements on the attached storage.

6. The method of claim 3, further including determining if the received file was a last file on a client computer's upload list.

7. The method of claim 6, wherein if the file was not the last file, repeating the steps of claim 3 until the last file of the client computer's upload list has been uploaded from the client computer.

8. The method of claim 6, wherein if the file was the last file, generating a backup complete report to the client computer identifying all of the files that have been uploaded successfully from the client computer.

9. The method of claim 3, further including determining if the received file is larger than a threshold file size, and if the received file is larger than the threshold file size, dividing the received file into a plurality of file parts because a size of the file was larger than a threshold file size and each of the plurality of file parts were received separately from the client computer and after the all of the plurality of file parts have been received, combining the file parts into a recreated file that is a replica of the received file.

10. The method of claim 3, wherein when the file is transferred to the attached storage, the file is copied into an upload folder on the attached storage.

11. The method of claim 3, wherein when the upload finish request is received and transmitted to the attached storage, the file is copied from the upload folder to a user folder on the attached storage.

12. A method of downloading data to a client computer, the data being stored at a remote location, the method comprising:
receiving a restore data request from the client computer, the restore data request including a restore date;
querying a database to generate a list of files that have been uploaded from the client computer after the restore date and transmitting the list of files to the client computer;
receiving a download session request and updating a database history;
receiving a file identification from the client computer; retrieving a stored file corresponding to the file identification and transferring the stored file to a user download file on an attached storage; and
updating the database history.

13. The method of claim 12, wherein the stored file is split into parts before being transferred to the user download file and a part count is generated.

14. The method of claim 13, wherein the part count is transmitted to the client computer.

15. The method of claim 12, further including receiving a finish download request for the stored file from the client computer and updating the database history with a time of the finish download request for the stored file.

16. The method of claim 13, further including receiving a finish download session request from the client computer and updating the database history to identify a time in which all of the files on the list of files are downloaded to the client computer.

17. A method to disinfect uploaded files from a client computer before the uploaded files are stored in an attached storage, comprising:
querying a database to generate a list of uploaded files which need to be scanned for viruses and receiving said list of uploaded files;
retrieving a first file included in the list of uploaded files and copying the first file to a scan folder;
scanning the copied first file for viruses; and
updating the database with a result of the scanning of the file.

18. The method of claim 17, further including determining whether the first file is the last file in the list of uploaded files and based on the said determining, terminating the disinfecting method.

19. The method of claim 17, further including determining whether the first file is the last file in the list of uploaded files and, if the first file is not the last file in the list of uploaded files, then repeating the copying, scanning, and updating steps.

20. A method of optimizing storage on an attached storage of a spare backup system, comprising:
querying a database to generate a list of optimizable files for a client computer in order to decrease storage requirements, the optimizable files being files that have been modified or accessed since a previous optimizing scan;
retrieving a first file of the list of optimizable files from the attached storage and copying the retrieved first file into a scan folder;
comparing the copied first file of the list of optimizable files to a previously stored file corresponding to the first file to create a difference map, the difference map being a listing of the differences between the first file and the previously stored file; and
storing the difference map as a patch file in the attached storage.

21. The method of claim 20, wherein the first file is deleted from the attached storage and replaced by the patch file.

22. The method of claim 20, wherein the patch file is stored in the folder corresponding to the client computer on the attached storage.

23. The method of claim 20, further including determining if the first file was the last file in the list of optimizable files and if the first file was not the last file, then repeating the retrieving, comparing, and storing steps for a next file in the list of optimizable files.
